(19) United States
(12) Patent Application Publication
(10) Pub. No.: US 2014/0372883 A1
(43) Pub. Date: Dec. 18, 2014

(54) Instructing an Operation to be Performed at a Central Station from a Remote Station

(71) Applicant: Fortnox AB, Vaxjo (SE)

(72) Inventor: Alexander Bonnevier, Vaxjo (SE)

(21) Appl. No.: 14/304,230

(22) Filed: Jun. 13, 2014

(30) Foreign Application Priority Data
Jun. 15, 2013 (EP) 13 250 067.9

(51) Int. Cl. H04L 29/08; H04L 12/24

(52) U.S. Cl. CPC H04L 67/025; H04L 41/22
USPC 715/704

(57) ABSTRACT

A remote station is configured to convey instructions to a central station. The remote station receives a plurality of input commands to effect an operation at said central station, stores them sequentially in a cache and asynchronously conveys them to the central station. If the remote station receives an error message from the central station indicating that an unexpected event was detected, the remote station identifies a set of sequential cached input commands and sequentially re-conveys them to the central station so as to determine if one of them was the cause of the unexpected event.

### CROSS REFERENCE TO RELATED APPLICATIONS

This application claims priority from European Patent Application No. 13 250 067.9, filed 15 Jun. 2013.

### BACKGROUND OF THE INVENTION

1. Field of the Invention

The present invention relates to a method of instructing an operation to be performed at a central station from a remote station

2. Description of the Related Art

Procedures are known for generating instructions at a remote station that are then conveyed to a central station and acted upon at said central station. The central station may then be in a position to produce output signals for controlling operations, such as manufacturing processes for example.

Systems of this type are increasingly being deployed using technology generated to support the worldwide web and include, for example, the use of asynchronous JavaScript with XML or JSON. Collectively, this technology may be referred to as AJAX.

Prior to the use of this known asynchronous technology, similar platforms were implemented using synchronous technology. When using synchronous technology, a command may be generated at a remote station and conveyed to a central station. At the central station a question may be asked as to whether it is possible to act upon the command or a plurality of commands and the remote station would be frozen out from further operation until a response had been received. Consequently, if a problem exists, this is quickly brought to the attention of the operator and appropriate action can be taken.

In an asynchronous environment, an unexpected event may occur in response to input commands. However these commands may have been generated sometime ago and it may have taken some time to actually convey the commands to the central station; given the asynchronous nature of the communication. Thus, further commands will have been received so a greater problem exists in terms of identifying the relationship between cause and effect.

When using program controlled systems, it is possible for debugging operations to be completed successfully in relation to procedures conducted at the remote station and for procedures conducted at the central station. However, even when thorough testing has been performed on each system individually, unexpected events may still arise when the systems are working together. An emergent problem may manifest itself which was not anticipated when considering each of the component systems individually. Consequently and particularly within asynchronous systems, it may become difficult to identify the cause of the unexpected event which would in turn introduce substantial delays before a solution could be provided. Furthermore, in some applications when controlling external machinery for example, these emergent errors could introduce very serious problems, while being produced by individual components that have satisfied rigorous testing activities.

### BRIEF SUMMARY OF THE INVENTION

According to a first aspect of the present invention, there is provided a method of instructing an operation to be performed at a central station from a remote station, comprising the steps of receiving a plurality of input commands at the remote station to effect an operation at the central station, storing the input commands sequentially in a cache at the remote station, to create a plurality of stored input commands, asynchronously conveying the input commands from the remote station to the central station, receiving, at the remote station, an error message from the central station indicating that an unexpected event was detected, identifying a set of input commands, wherein the set comprises a sequential plurality of the stored input commands, and sequentially re-conveying the set of input commands from the cache to the central station so as to determine if one of the set of input commands was the cause of the unexpected event.

According to a second aspect of the present invention, there is provided a remote device configured to convey instructions to a central station, comprising an input device for receiving input commands, a processor configured to asynchronously convey the input commands to a central station; and a cache for sequentially storing the input commands, wherein the processor is configured to replay a sequential plurality of the commands from the cache to repeat an input driven sequence.

According to a third aspect of the present invention, there is provided a central station configured to receive input commands from a remote station, comprising a processor, storage and a communication channel; wherein the processor is configured to receive, via the communication channel, input commands from the remote station, process asynchronously the received input commands, act upon the received input commands, and identify an unexpected event and instruct the remote station to replay previously received input commands, whereupon the remote station reads the previously received input commands from a cache and replays a sequential plurality of the input commands.

### BRIEF DESCRIPTION OF THE DRAWINGS

FIG. 1 shows an environment for instructing an operation;

FIG. 2 shows a protocol diagram of transmissions performed within the environment of FIG. 1;

FIG. 3 shows an example of a remote station;

FIG. 4 shows operations performed by a processor at the remote station;

FIG. 5 details further operations performed at the remote station;

FIG. 6 shows an example of a central station;

FIG. 7 identifies instructions performed at the central station; and

FIG. 8 details further procedures performed at the central station.

### DETAILED DESCRIPTION OF EXAMPLE EMBODIMENTS

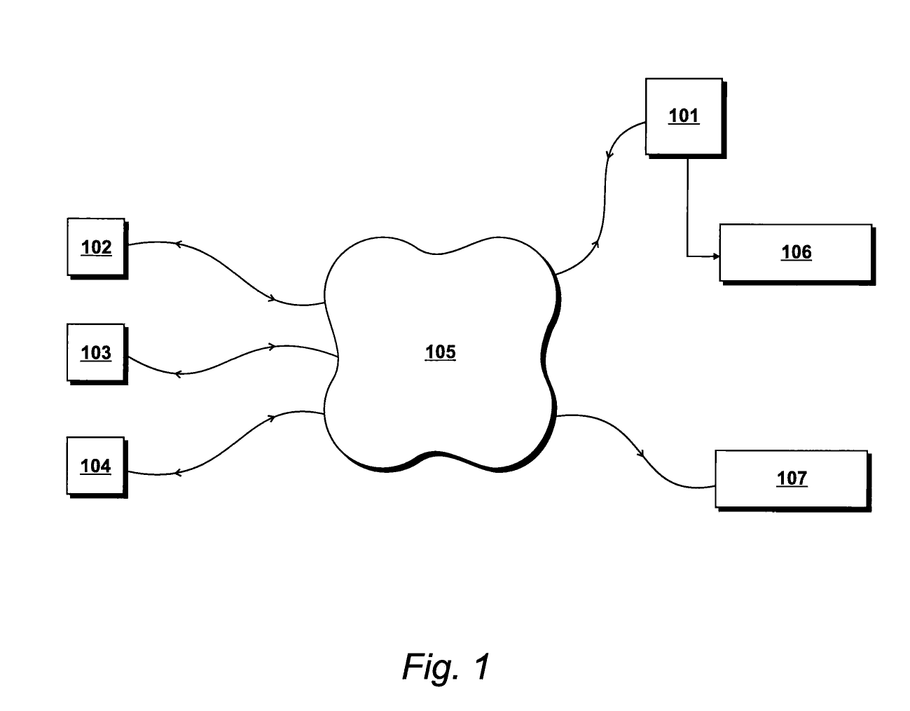

### FIG. 1

An environment for instructing an operation to be performed at a central station 101 from a remote station 102 is illustrated in FIG. 1. For the purposes of this example, a second remote station 103 is shown, along with a third remote station 104. Each of these remote stations 102 to 104 communicates with the central station 101, and the central station may maintain individual sessions for each of these remote stations.

Communication takes place via a network 105, the exact nature of which is not relevant to the invention. However, it may include wireless communications, including cellular communications, and may deploy internet protocols.

Following processing operations performed at the central station 101, in response to commands received from the remote stations, such as remote station 101, output commands are generated to external devices. In an embodiment, a first external device 106 is shown communicating directly with the central station 101. In addition, a further external device 107 is shown communicating via network 105.

Thus, input commands are received at a remote station, such as remote station 102, to effect an operation at the central station 101. Input commands at the remote station 102 are asynchronously conveyed to the central station 101. At the remote station 102, input commands are cached sequentially. Having cached these input commands, it is possible for one or more of these commands to be replayed from the cache to repeat an input-driven sequence to identify the cause of an unexpected event.

An unexpected event is any event identified by the central station that differs from the expected outcome of the commands. An unexpected event may have limited consequences and may merely represent a situation in which the outcome is in some way different from that which was expected. Thus, even under these circumstances, where the alternative outcome may be totally acceptable, it may be advantageous to ascertain the reason as to why this unexpected event occurred.

However, when an unexpected event results in undesirable commands being sent to the external devices 106, 107, it may be much more important, possibly damaging and even catastrophic. Thus, if such an unexpected event is identified, it is useful to identity the reason for the event and rapidly take steps towards correcting it. An unexpected event may even result in failure of operations performed by the central station 101: effectively a systems crash. Under these circumstances, it may be very difficult to recover the status of information held at the central station 101 and therefore there may be little evidence remaining to identify the cause of the unexpected event. However, given that instructions will have been cached at the remote station 102, it is possible to re-establish the status of the central station 101 to a previous instance and then repeat selections of the commands that were issued until the particular command or commands causing the failure can be isolated.

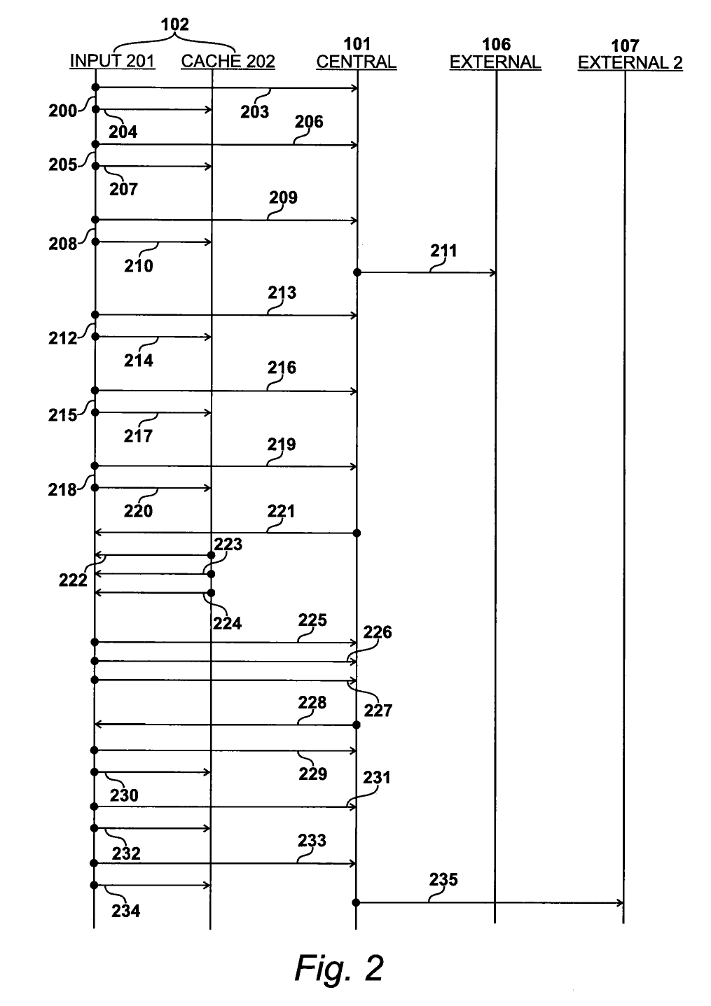

### FIG. 2

A protocol diagram showing an example of transmissions performed within the environment of FIG. 1 is shown in FIG. 2. Remote station 102 includes an input device 201 and a cache 202. An input signal generated at 200 is supplied to the central station 101. In addition, this input signal is also supplied, at 204, to the cache 202. Thus, in addition to the input instruction being supplied, via network 105, to the central station 101, a copy of this instruction is also retained in cache 202.

In this example, a further input signal is generated at 205 and this is again supplied to the central station 101 at 206 and written to cache at 207.

A third input signal 208 is again supplied at 209 to the central station 101 and at 210 it is written to cache 202. For the purposes of this example, the central station 101 has now received a sufficient number of commands for it to generate an output signal at 211 which, for the purposes of this example, is supplied directly to external device 106.

A similar sequence of events then follows, initiated by input 212. At 213 an input command is supplied to central station 101 and at 214 the command is written to cache 202. A further input command 215 follows which again is supplied to central station 101 at 216 and written to cache at 217. A third input 218 follows, conveyed to central station 101 at 219 and written to cache at 220. For the purposes of this example, an operator at remote station 102 would then expect a further output signal to be generated by the central station 101, possibly intended for external device 107. However, for the purposes of this example, it is assumed that an unexpected event has occurred at the central station 101, possibly due to a programming error, a user error, a transient error or a data error for example. Thus, central station 101 is not in a position to issue an output command but instead returns an error message at 221 to remote station 102.

At remote station 102 it may be assumed that the recently transmitted commands (213, 216 and 219) have caused the problem. The nature of the problem may be unknown therefore in order to identify the cause, it is possible for the session to be repeated. Thus, the commands written to cache 202 at 214, 217 and 220, are read from cache at 222, 223 and 224. The session, made up of communications 213, 216 and 219, is then repeated by issuing the commands again at 225, 226 and 227. For the purposes of this example, it is assumed that an error occurs again and this is relayed back to the remote station 102 at 228.

For the purposes of this example, it is assumed that the nature of the error has now been analysed and corrections have been made. It is therefore possible to repeat the session with these corrections in place. Thus, a modified command is issued at 229 and again this is written to cache at 230. The second modified command is issued at 231 and written to cache at 232. Finally, a third command is issued at 233 and written to cache at 234. For the purposes of this example, is it assumed that an unexpected event does not occur and that procedures follow as intended; resulting in the central station 101 issuing a command to external device 107, as shown at 235, via network 105.

In an embodiment, the central station 101 may include a database, and operations performed at the central station 101, in response to input commands, may involve updating this database. Furthermore, as previously described, the central station may also communicate with external devices and an operation, derived from instructions from a remote station, may involve supplying control signals to the external devices. These control signals may be generated directly or, alternatively, may be a result of modifications made to the database. Thus, in an embodiment, a plurality of events could modify entries in a database, which then results in output signals being supplied to the external devices.

In an embodiment, the remote station is a portable station communicating via a radio channel. The radio channel may operate within a wireless environment or a cellular environment.

In an embodiment, the input commands are generated by manual interaction with the graphical user interface. The graphical user interface may be presented on a touch sensitive screen. The remote station may include non-volatile memory and the cache may be established within a region of this non-volatile memory.

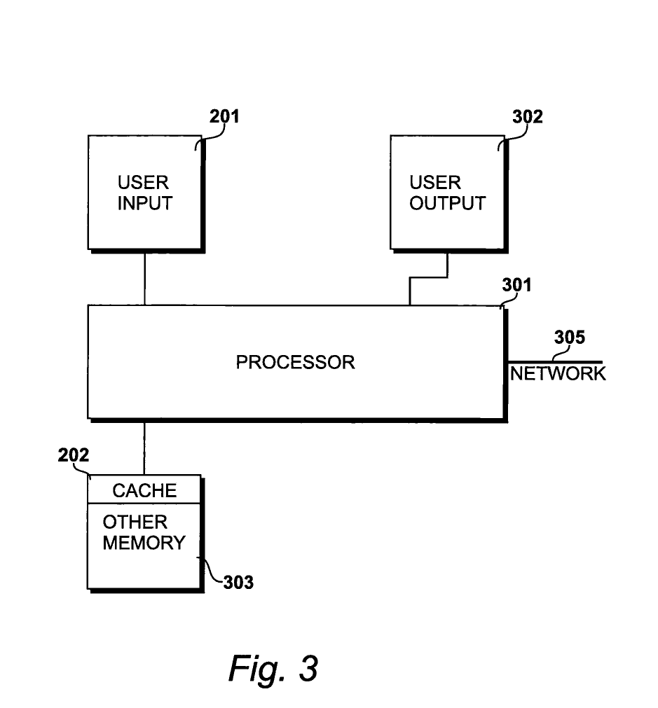

### FIG. 3

An example of a remote station 102 is detailed in FIG. 3. The remote station includes a processor 301 configured to receive input commands from the user input device 201 and to display an output interface to a user via an output display 302. The processor may be any processing device capable of being configured to carry this out, the input device may be any device capable of providing user commands to the processor, and the output device may be any device capable of displaying output data to a user. The input device and output device may be provided by a single apparatus, such as a touch-screen display, or by separate apparatus such as a display and a keyboard.

The processor 301 sends data to and receives data from a memory 303. Within the memory 303 there is the local cache 202. The memory may be any suitable memory or storage device capable of being configured to store, read and cache data. As previously described, the local cache 202 enables the remote device 102 to retain a record or history of the input commands that have been received locally, prior to or after being conveyed to the central station. In an embodiment, the input commands may be acted upon locally, prior to being conveyed, as described in the applicant's co-pending US patent application (4148-P101-US).

Network connection 305 provides a communication channel by which the remote station 102 communicates with central station 101 via network 105, and may be any network device or other communication method suitable for communicating with another station.

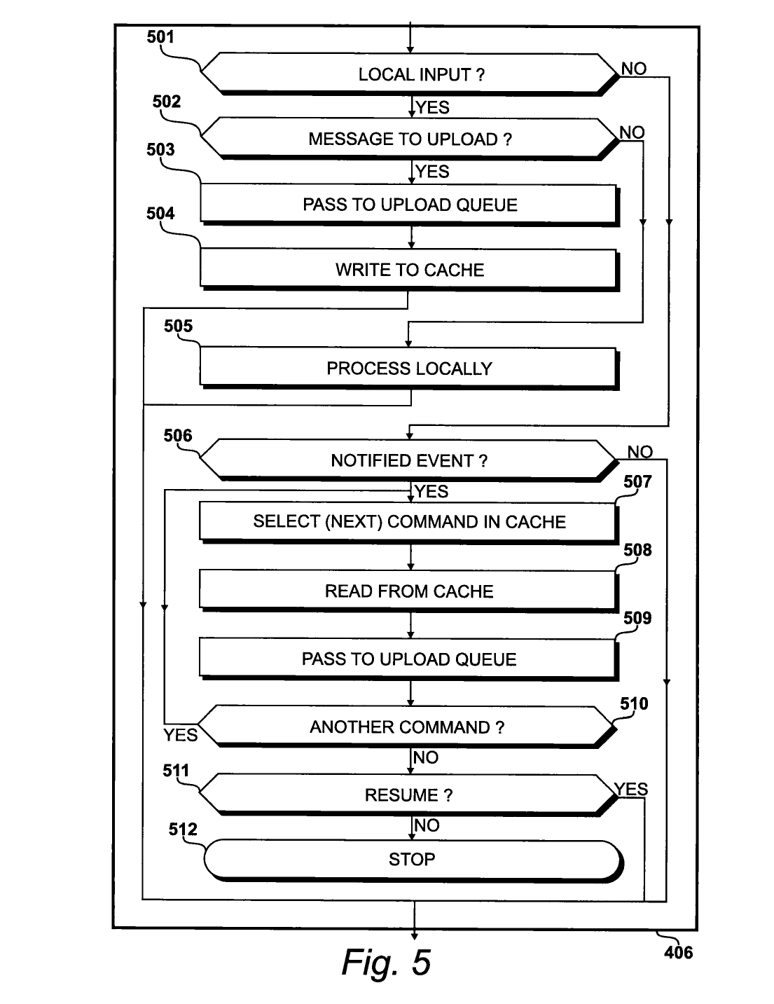

Thus, the remote device is configured to convey instructions to the central station by providing an input device 201 for receiving input commands and a processing device 301 configured to asynchronously convey the input commands to a central station 101. A cache 202 is provided for sequentially caching the input commands. Furthermore, the processor 301 is configured to replay one or more of said input commands from the cache 202 to repeat an input-driven sequence to identify the cause of the unexpected event, as detailed in FIG. 5.

The remote device may include a radio communication device for facilitating portability, along with a display device for displaying a graphical user interface. The display device may itself be touch sensitive, such that the displayed graphical interface is also responsive to received input data. In an embodiment, the remote device includes non-volatile memory, with portion 202 of the non-volatile memory being configured to establish the cache; with remaining memory 303 being available for performing other operations.

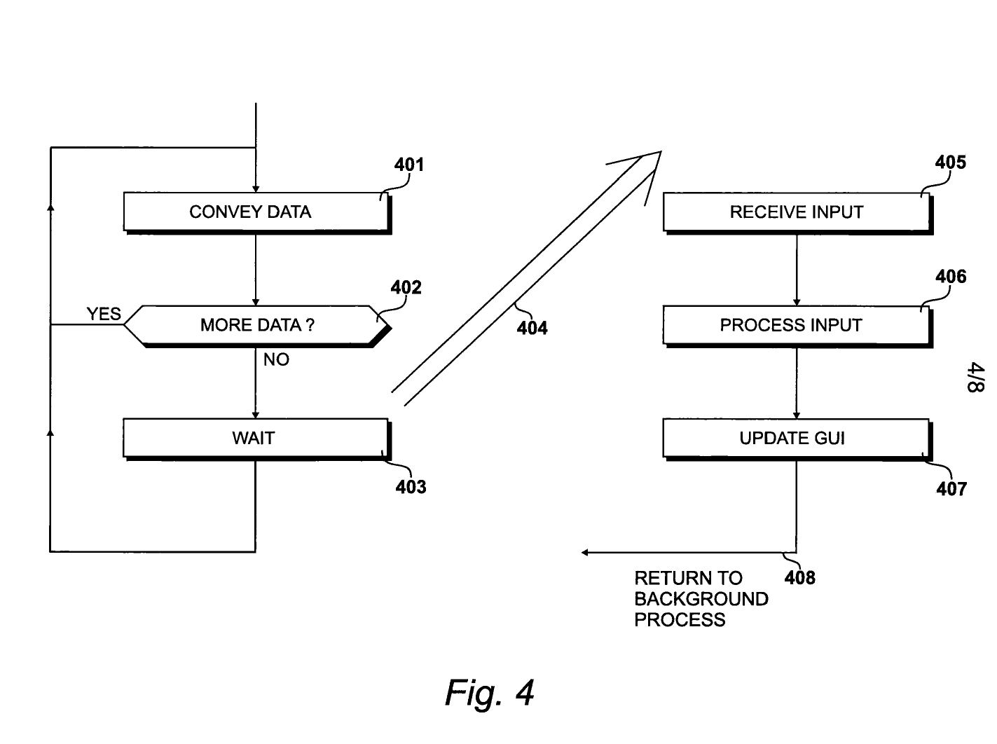

### FIG. 4

Operations performed by processor 301 are illustrated in FIG. 4. Foreground processes are shown to the right and the background asynchronous processes are shown to the left. When not required to perform operations in response to local input, the processor 401 attempts to convey data, as shown at step 401, to the control station via its local network connection 305 and then on to the wider network 105. This communication channel may include wireless connections, including cellular connections.

After conveying data at step 401, a question is asked at step 402 as to whether more data is available and when answered in the affirmative, this further data is again conveyed at step 401.

If the question asked at step 402 is answered in the negative, the procedure may enter a wait state at step 403 and then again loop around to step 401 to continue conveying any additionally received data to the central station 101.

At any time during the operations being performed from step 401 through step 403, the processor 301 may receive an interrupt, as illustrated by arrow 404. The processor 301 immediately enters a routine to service the interrupt, possibly involving the stacking of data currently held in memory; whereupon it is then in a position to receive input data at step 405. At step 406 the input data is processed and at step 407 the graphical user interface displayed to the user, via output display 302, is updated.

After the completion of the interrupt being serviced, the processor returns to attending to the background processes as illustrated by arrow 408.

### FIG. 5

Processes 406, indentified in FIG. 4, are detailed in FIG. 5. An input command was received at step 405, therefore a question is asked at step 501 as to whether this is a local input. For the purposes of illustration, a local input will represent a user command whereas a non-local input will have been received from the central station 101. Thus, input 203 represents a local input whereas input 221 represents an external input. Processes 502 through 505 attend to the servicing of a local input and processes 506 through 511 attend to the processing of an external input.

In response to the question asked at step 501 being answered in the affirmative, representing an internal input, a question is asked at step 502 as to whether a message has been received that is to be uploaded to the central station 101. Thus, a distinction is made between an input command that may relate exclusively to local activities, as distinct from an input command that requires uploading to the central station 101. Thus, when the question asked at step 502 is answered in the affirmative, the received command is passed at step 503 to an upload queue. Thus, when supplied to the upload queue, the instruction will be conveyed asynchronously to the central station 101 as part of the background process. Thus, this represents communication 203 and is followed by step 504 resulting in the command being written to cache 202, represented by communication 204. Thereafter, the graphical user interface is updated at step 407.

If the question asked at step 502 is answered in the negative, to the effect that the input message does not need to be conveyed to the central station, local processing occurs at step 505.

If the question asked at step 501 is answered in the negative, the processor is required to process the external input. A question is asked at step 506 as to whether the external input represents a notification of an unexpected event, as represented by communication 221 and communication 228 in FIG. 2. If answered in the negative, the event relates to other matters outside the scope of this disclosure. If the question asked at step 506 is answered in the negative, an unexpected event has occurred and the re-running of cached instructions is then implemented.

At step 507 a command from cache is selected and at step 508 the cached instruction is read. Thereafter, at step 509 the instruction read from cache is passed to the upload queue for uploading as part of the asynchronous procedure detailed in FIG. 4.

At step 510 a question is asked as to whether another command is present within the range of interest and when answered in the affirmative, control is returned to set 507, thereby allowing the next command in cache to be selected. Thus, this process repeats until the full range of commands have been read from cache and resupplied to the central station 101.

Thus, in the example shown in FIG. 2, the loop would repeat twice resulting in, for example, the re-issuing of communications 225, 226 and 227. Thereafter, when all of the commands have been retransmitted, the question asked at step 510 is answered in the negative. A question is then asked at step 511 as to whether the process should resume. Thus, when answered in the affirmative, control is directed to step 407 and the graphical user interface is updated as required. Alternatively, if problems still exist, it is possible for the question asked at step 511 to be answered in the negative resulting in the procedure stopping at step 512.

In an embodiment, a plurality of input commands are received at said remote station and these input commands are asynchronously conveyed to the central station. The input commands are stored in cache sequentially at the remote station and a plurality of these commands are replayed from the cache.

In an embodiment, the input commands are generated by a manual operation performed by a user upon an input device. The central station is configured to operate in a conventional mode prior to detecting an unexpected event. In addition, the control station operates in a diagnostic mode after detecting the unexpected event.

The control station may be configured to receive manual input controls from an operator during the diagnostic mode. In this diagnostic mode, a sequence of input commands may be replayed from cache while the control operator communicates with the remote user. Thus, the control operator could communicate with the remote user via an alternative communications channel, such as by telephone for example. In this way, if an end user has a problem, it is possible for the control operator to perform a walk-through operation with an end user making reference to the sequence of stored events. In this way, it should be possible to identify the cause of the unexpected event, be that be due to an erroneous instruction, an erroneous action or due to a user failing to do what they had intended to do.

In an alternative embodiment, it is possible for the control station to receive manual input controls from a programmer during the diagnostic mode. A sequence of input commands may be replayed from cache under the control of the programmer. The programmer may introduce changes to instructions executed at the central station or at the remote station. A sequence of input commands are then replayed from cache, so as to test the validity of the new instructions. In this way, new instructions may be tested with reference to a recording of real input commands initiated by a real user. Thus, the new instructions may be tested in a diagnostic mode that accurately reflects real input, without the programmer themselves being required to emulate a sequence of real input commands.

In an alternative embodiment, the control station may receive new instructions. Alternatively, or in addition, a remote station may receive new instructions. In this way, during a diagnostic mode, a sequence of input commands are replayed to reproduce the actions of a remote user. An output may be produced identifying the success or failure of these new instructions.

In this way, it is possible for a programmer to replay an entire sequence of input commands automatically, thereby artificially reproducing the actions of a real end user, when testing new program instructions. Tests of this type, during a diagnostic mode, may run automatically with the results, a success or a failure, being reported to the programmer after many runs of this type being completed.

In an alternative embodiment, the control station instructs a plurality of remote stations to replay stored input commands from their respective cache during the diagnostic mode in order to stimulate a load condition. The control station generates an output indicating the ability of the control station to function as intended under this load condition. Thus, in this way, a programmer can execute a large number of recorded cache instructions replayed together to simulate the effect of many users on the system at the same time; generally referred to as “load testing”. Such an operation is designed to stress the system under simulated heavy load conditions so that a programmer may determine the extent to which the system is able to cope.

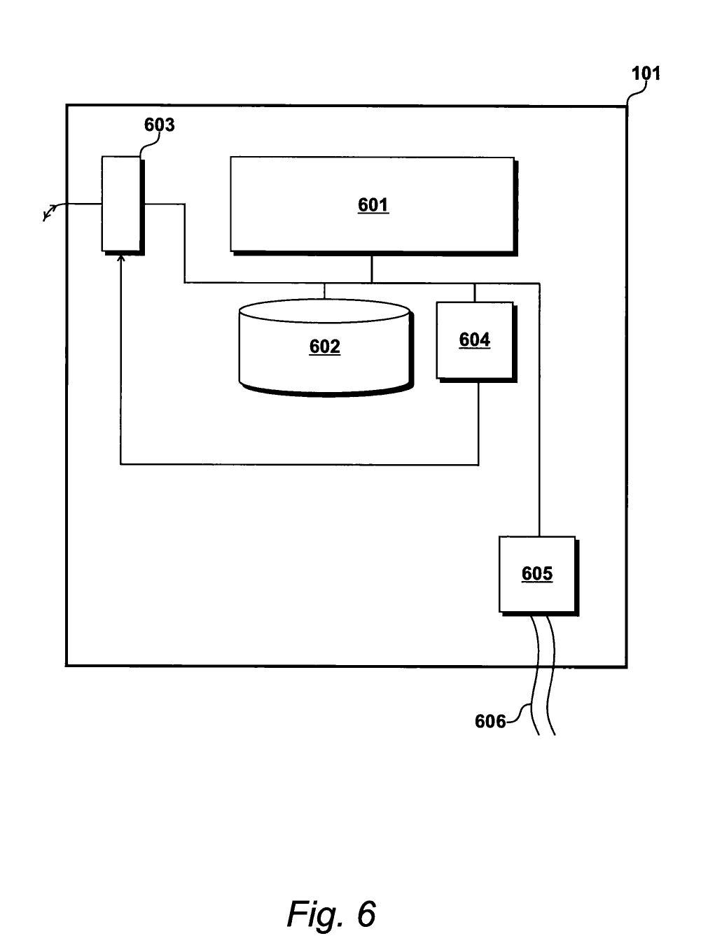

### FIG. 6

An example of central station 101 is detailed in FIG. 6. A processor 601 communicates with permanent storage device 602. Within said permanent storage device, a database is defined comprising a plurality of database tables. In this embodiment, the processor is provided by a single processing device 601, but in an alternative embodiment the processor is provided by a plurality of processing devices; the total number of which being determined by the total number of sessions that are required to run concurrently. This in turn will be determined by the number of remote stations (101 to 104) communicating with a central station 101. Although three examples are shown in FIG. 1, the total number of remote stations could be in the tens of thousands.

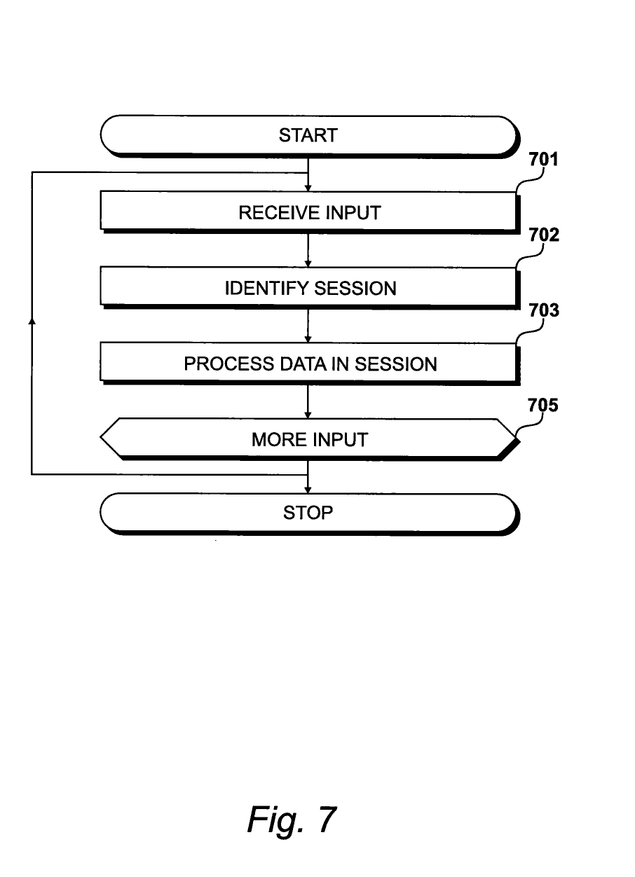

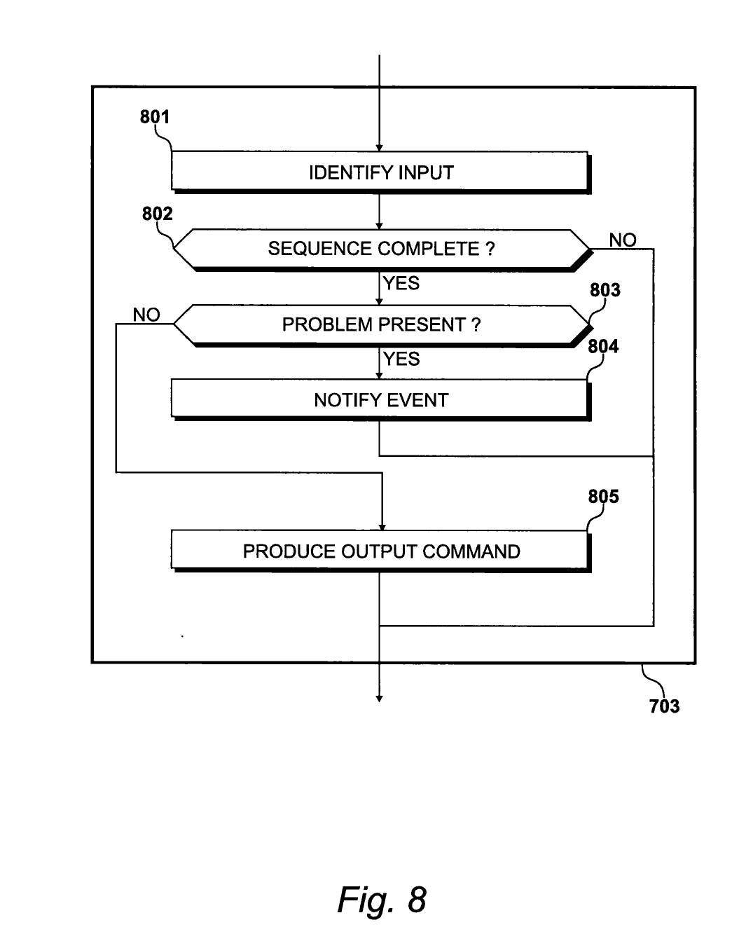

An input device 603 provides a receiving means configured to receive input commands asynchronously, such that these input commands can be processed by the processor 601. The processor 601 is also configured to act upon these received commands, as detailed in FIGS. 7 and 8.

In addition to instructions being received from the remote stations via input device 603, device 603 also operates as an output device for conveying notifications back to remote stations. Thus input device 603 may be any communication, network or input device capable of receiving and conveying messages.

In this embodiment additional rollback means 604 are configured to instruct a remote station to rollback to previously received instructions, but in other embodiments the rollback means may be processor 601, configured to perform additional rollback functions. As previously described, when a remote station is instructed to rollback previously received instructions, the processor at the remote station is configured to replay instructions, so as to identify the cause of an unexpected event.

In an embodiment, action means are configured to perform operations upon the database retained within storage 602. Furthermore, an interface 605 may be provided that is configured to control the external devices, via an output transmission channel 606, either directly or in response to an analysis of data contained within the database.

### FIG. 7

An example of instructions performed by processor 601 is detailed in FIG. 7. At step 701 input commands are received and at step 702 the session is identified, the processor 601 being configured in a multi-tasking environment and servicing many sessions for respective remote stations.

At step 703 the data in the session is processed and at step 705 a question is asked as to whether more input is to be considered. When answered in the affirmative, control is returned to step 702 and the process is repeated.

### FIG. 8

Procedures 703 for processing data in a session are detailed in FIG. 8. At step 801 an input is identified and a question is asked at step 802 as to whether the sequence is complete. When answered in the negative, more input is required therefore control is directed to step 705.

When the question asked at step 802 is answered in the affirmative, to the effect that the sequence is complete, a question is asked at step 803 as the whether a problem is present. When answered in the negative, control is directed towards step 805 and, where appropriate, an output command is generated. Thus, this situation represents that illustrated in FIG. 2 in which input commands 203, 206 and 209 have been identified resulting in output command 211.

When the question asked at step 803 is answered in the affirmative, to the effect that a problem has been identified, the event is notified at step 804. This results in the notification being conveyed back to the remote station, as illustrated in communication 221 for example.

What we claim is:

1. A method of instructing an operation to be performed at a central station from a remote station, comprising the steps of:
receiving a plurality of input commands at said remote station to effect an operation at said central station;
storing said input commands sequentially in a cache at said remote station, to create a plurality of stored input commands;
asynchronously conveying said input commands from said remote station to said central station;
receiving, at said remote station, an error message from said central station indicating that an unexpected event was detected;
identifying a set of input commands, wherein said set comprises a sequential plurality of said stored input commands; and
sequentially re-conveying said set of input commands from said cache to said central station so as to determine if one of said set of input commands was the cause of said unexpected event.

2. The method of claim 1, wherein said central station includes a database and said operation involves updating said database.

3. The method of claim 1, wherein said central station communicates with external devices and said operation involves supplying control signals to said external devices.

4. The method of claim 1, wherein said input commands are generated by manual interaction with a graphical user interface.

5. The method of claim 1, wherein:
an input command is generated by a manual operation performed by a user upon an input device;
said central station operates in a conventional mode prior to detecting said unexpected event; and
said central station operates in a diagnostic mode after detecting said unexpected event.

6. The method of claim 5, wherein:
said central station receives manual input controls from a control operator during said diagnostic mode; and
a sequence of input commands is replayed from said cache while said control operator communicates with said remote user.

7. The method of claim 5, wherein:
said central station receives manual input controls from a programmer during said diagnostic mode;
a sequence of input commands is replayed from said cache under the control of said programmer;
said programmer introduces changes to instructions executed at said central station or at said remote station; and
said sequence of input commands replayed from said cache is replayed again.

8. The method of claim 5, wherein:
said central station and/or said remote station receive new instructions during said diagnostic mode;
a sequence of input commands is replayed to reproduce the actions of a remote user; and
an output is produced identifying the success or failure of said new instructions.

9. The method of claim 5, wherein:
said central station instructs a plurality of remote stations to replay stored input commands from their respective cache during said diagnostic mode to simulate a load condition; and
said central station generates an output indicating the ability of said central station to function as intended under said load condition.

10. A remote device configured to convey instructions to a central station, comprising:
an input device for receiving input commands;
a processor configured to asynchronously convey said input commands to a central station; and
a cache for sequentially storing said input commands;
wherein said processor is configured to replay a sequential plurality of said commands from said cache to repeat an input driven sequence.

11. The remote device of claim 10, including non-volatile memory, wherein a portion of said non-volatile memory is configured to establish said cache.

12. A central station configured to receive input commands from a remote station, comprising a processor, storage and a communication channel; wherein said processor is configured to:
receive, via said communication channel, input commands from said remote station;
process asynchronously said received input commands;
act upon said received input commands; and
identify an unexpected event and instruct said remote station to replay previously received input commands,
whereupon said remote station reads said previously received input commands from a cache and replays a sequential plurality of said input commands.

13. The central station of claim 12, including a database, wherein said processor is configured to act upon said received commands by performing operations upon said database.

14. The central station of claim 13, wherein output events for controlling external devices are generated in response to analysing data from said database.

15. The central station of claim 12, wherein:
said central station operates in a conventional mode prior to detecting said unexpected event; and
said central station operates in a diagnostic mode after detecting said unexpected event.

16. The central station of claim 15, wherein during said diagnostic mode:
said central station receives manual input controls from a control operator; and
a sequence of input commands is replayed from said cache.

17. The central station of claim 15, wherein during said diagnostic mode:
said central station receives manual input controls from a programmer during said diagnostic mode;
a sequence of input commands is replayed from said cache under the control of said programmer;
said programmer introduces changes to instructions executed at said central station or at said remote station; and
said sequence of input commands replayed from said cache is replayed again.

18. The central station of claim 15, wherein during said diagnostic mode:
said central station receives new instructions;
a sequence of input commands is replayed to reproduce the actions of a remote user; and
an output is produced identifying the success or failure of said new instructions.

19. The central station of claim 15, wherein:
said central station instructs a plurality of remote stations to each replay stored input commands from their respective cache during said diagnostic mode to simulate a load condition; and
said central station generates an output indicating the ability of said central station to function as intended under said load condition.
